(19) United States
(12) Patent Application Publication
(10) Pub. No.: US 2005/0250617 A1
(43) Pub. Date: Nov. 10, 2005

(54) Transmission

(76) Inventor: Masahiro Sagawa, Yokosuka-shi (JP)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/112,001

(22) Filed: Apr. 22, 2005

Related U.S. Application Data
(63) Continuation of application No. PCT/JP03/13326, filed on Oct. 17, 2003.

(30) Foreign Application Priority Data
Oct. 24, 2002 (JP) 2002-309170

(51) Int. Cl. F16H 15/38

(52) U.S. Cl. 476/40

(57) ABSTRACT

A transmission comprises a first roller having a first repeated number of first grooves on the outer circumferential surface of a first shaft body having a cross-sectional circular shape in the perimeter direction, a second roller having a second repeated number of second grooves in the perimeter direction on the outer circumferential surface of a second shaft body having a cross-sectional circular shape, and a cylinder-shaped third roller having plural grooves extending in the axial direction with intervals in the perimeter direction on the inner diameter surface. The second repeated number is different from the first repeated number. The first roller and the second roller each face the third roller via plural first rolling elements positioned in the first grooves and plural second rolling elements positioned in the second grooves.

### REFERENCE TO RELATED APPLICATION

This application is a continuation of the PCT International Application No. PCT/JP2003/013326 filed on Oct. 17, 2003, which is based on the Japanese Application No. 2002-309170 filed on Oct. 24, 2002.

### BACKGROUND OF THE INVENTION

The present invention relates to a transmission, and particularly, relates to a ball-type transmission.

Various types of transmission have been proposed for this type of transmission, and several examples thereof will be described below.

A first example is a reduction gear comprising an input rotary shaft, first and second endless cam grooves formed in a periodic functionally curved manner each of which the axial center line direction is taken as a vertical axis and the circumferential direction is taken as a horizontal axis with estrangement over the outer circumferential surface of this input rotary shaft in the axial center line direction, and a cylinder body mounted on the outside of the input rotary shaft so as to rotate concentrically with the input rotary shaft. The reduction gear further comprises a third endless cam groove formed in a periodic functionally curved manner having the same amplitude value as the first endless cam groove on a portion opposing to the first endless cam groove over the inner circumferential surface of this cylinder body in the same way as the first endless cam groove, and a fourth endless cam groove formed in a periodic functionally curved manner having the same amplitude value as the second endless cam groove on a portion opposing to the second endless cam groove over the inner circumferential surface of this cylinder body in the same way as the second endless cam groove. The reduction gear still further comprises rolling elements each intervened in a position where the first endless cam groove and the third endless cam groove are intersected with each other between the first and third endless cam grooves, and also a position where the second cam groove and the fourth cam groove are intersected with each other between the second and fourth endless cam grooves. The reduction gear yet further comprises a stationary first holding member holding the rolling element positioned between the first and third cam grooves so as to move the rolling element in the axial center line direction, a second holding member holding the rolling element positioned between the second and fourth endless cam grooves so as to move the rolling element in the axial center line direction, and also so as to be rotatably supported centered on the axial center line, and an output rotary shaft connected to this second holding member.

That is to say, with the first example, the first and second endless cam grooves are formed on a large diameter portion connected with the input shaft, the first endless cam groove is coupled to the first holding member via the rolling element, i.e., the ball, and the second endless groove is coupled to the second holding member connected with the output shaft via the rolling element, i.e., the ball (see Japanese Unexamined Patent Application Publication (JP-A) No. 59-180153, for example).

A second example is a cap-type gearless transmission comprising two shafts each supported so as to rotate over the same axial line, an inner cylinder fixed on the end portion of one shaft, and an outer cylinder fixed on the end portion of the other shaft and facing the outer surface of the inner cylinder. The gearless transmission further comprises an endless tilting groove and plural sine wave grooves of which one is disposed on any one of the facing surfaces between the inner cylinder and outer cylinder, and the other is disposed on the other facing surfaces. The gearless transmission still further comprises a guide cylinder of which plural narrowly long windows different from the number of the sine wave grooves are opened in the isometric axial line direction inserted in a gap between the inner cylinder and outer cylinder so as to rotate, and balls each inserting in each narrowly long window so as to roll and engaging with the tilting groove and sine wave groove (see Japanese Unexamined Patent Application Publication (JP-A) No. 60-179563, for example).

However, with the first example, two winding grooves need to be formed on the inner circumferential surface of the cylinder body, and even with the second example, a winding groove needs to be formed on the inner surface of the outer cylinder, so working is difficult and troublesome.

On the other hand, with the second example, further entry plugs for the balls need to be disposed on the rolling surface of the balls. Steps provided on the rolling surface by the entry plugs cause the service life of the balls to be shortened.

### SUMMARY OF THE INVENTION

Accordingly, an object of the present invention is to provide a transmission of which the working is relatively simple.

Another object of the present invention is to provide a transmission of which assembly is relatively simple, and also the service life of the balls can be increased.

A transmission according to the present invention comprises a first roller having a first repeated number of first grooves on the outer circumferential surface of a first shaft body having a cross-sectional circular shape in the perimeter direction, a second roller having a second repeated number of second grooves, which is different from the first repeated number, in the perimeter direction on the outer circumferential surface of a second shaft body having a cross-sectional circular shape, and a cylinder-shaped third roller having plural grooves extending in the axial direction with intervals in the perimeter direction on the inner diameter surface. The first roller and the second roller each face the third roller via plural first rolling elements positioned in the first grooves and plural second rolling elements positioned in the second grooves.

In the present transmission, a retainer capable of sliding in the axial direction for holding the first rolling element and the second rolling element is disposed in each of the plural grooves of the third roller.

In the present transmission, a sliding member may intervene between the retainer and the third roller. In this case, the sliding member may be a rolling unit. Alternatively, the first and second rolling elements may serve as the sliding member. Also, an arrangement may be made wherein the sliding member may be realized by coating at least one of the facing portions between the retainer and the third roller with a friction reducing material, for example.

In the present transmission, when the first roller serves as an input shaft, any one of the third roller and the second roller is fixed, and the other serves as an output shaft.

In the present transmission, further, the first repeated number is represented by K_{S}, the second repeated number is represented by K_{S}·K_{I}, and the maximum number of the plural grooves is represented by K_{S}·(K_{I}±1).

It is preferable that the first and second rollers in the transmission are configured with a hollow shape.

The first and second grooves in the present transmission preferably have a symmetric shape such as a sine waveform, triangular waveform, or the like, but they may have an asymmetric shape. Also, the cross-sectional shapes of the first and second grooves are preferably any one of a simple arc shape, bearing arc shape, or triangular shape.

### BRIEF DESCRIPTION OF THE DRAWINGS

FIG. 1 is an external view illustrating an oscillating-type ball reduction gear according to a preferred embodiment of the present invention without a casing thereof;

FIG. 2 is an exploded view of FIG. 1;

FIG. 3 is an explanatory diagram for describing the positional relations illustrated in FIG. 2 between the first and second grooves formed on the first and second outer rollers, the retainers disposed in the inner roller, and the balls supported by the retainers regarding a case of a ball placement A and the inner roller fixed;

FIG. 4 is an explanatory diagram for describing the positional relations illustrated in FIG. 2 between the first and second grooves formed on the first and second outer rollers, the retainers disposed in the inner roller and the balls supported by the retainers regarding a case of the ball placement A and the second outer roller fixed;

FIG. 5 is an explanatory diagram for describing the positional relations illustrated in FIG. 2 between the first and second grooves formed on the first and second outer rollers, the retainers disposed in the inner roller and the balls supported by the retainers regarding a case of a ball placement B and the inner roller fixed;

FIG. 6 is an explanatory diagram for describing the positional relations illustrated in FIG. 2 between the first and second grooves formed on the first and second outer rollers, the retainers disposed in the inner roller and the balls supported by the retainers regarding a case of the ball placement B and the second outer roller fixed;

FIG. 7 is a diagram illustrating the relations between the number of rotations and a reduction ratio between the first and second outer rollers, and the inner roller regarding each case in FIG. 3 through FIG. 6;

FIG. 8 is a diagram illustrating a first example of particularly the shape of the second groove, of the first and second grooves illustrated in FIG. 2;

FIG. 9 is a diagram illustrating a second example of particularly the shape of the second groove, of the first and second grooves illustrated in FIG. 2;

FIG. 10 is a diagram illustrating a third example of particularly the shape of the second groove, of the first and second grooves illustrated in FIG. 2;

FIG. 11(a) through 11(c) are diagrams illustrating some examples regarding the cross-sectional shapes of the first and second grooves illustrated in FIG. 2;

FIG. 12(a) through 12(d) are diagrams illustrating another some examples the retainers employed in the present invention;

FIG. 13 is a cross-sectional view for describing the shape of a ball receiving portion formed in the retainers illustrated in FIGS. 12(a) and 12(b);

FIG. 14 is a cross-sectional view for describing the shape of a ball-receiving portion formed in the retainers illustrated in FIG. 12(d); and

FIG. 15 illustrates the actual device configuration accommodating the reduction gear according to an embodiment of the present invention in a casing.

### DESCRIPTION OF THE PREFERRED EMBODIMENTS

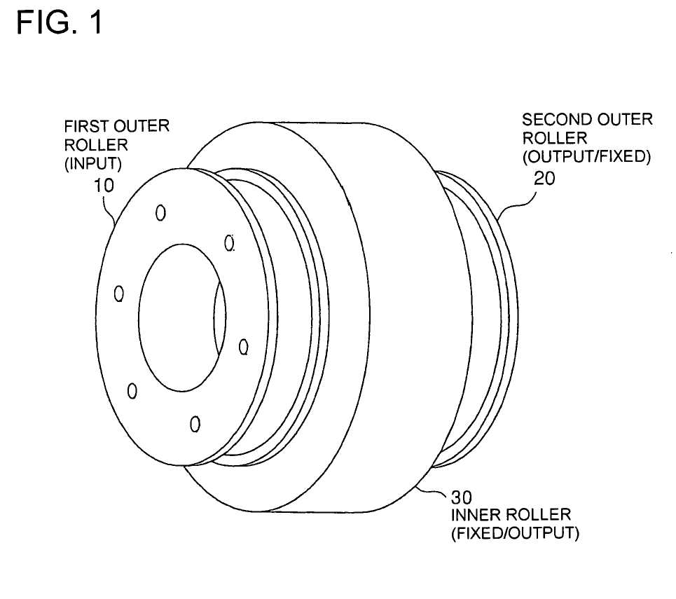

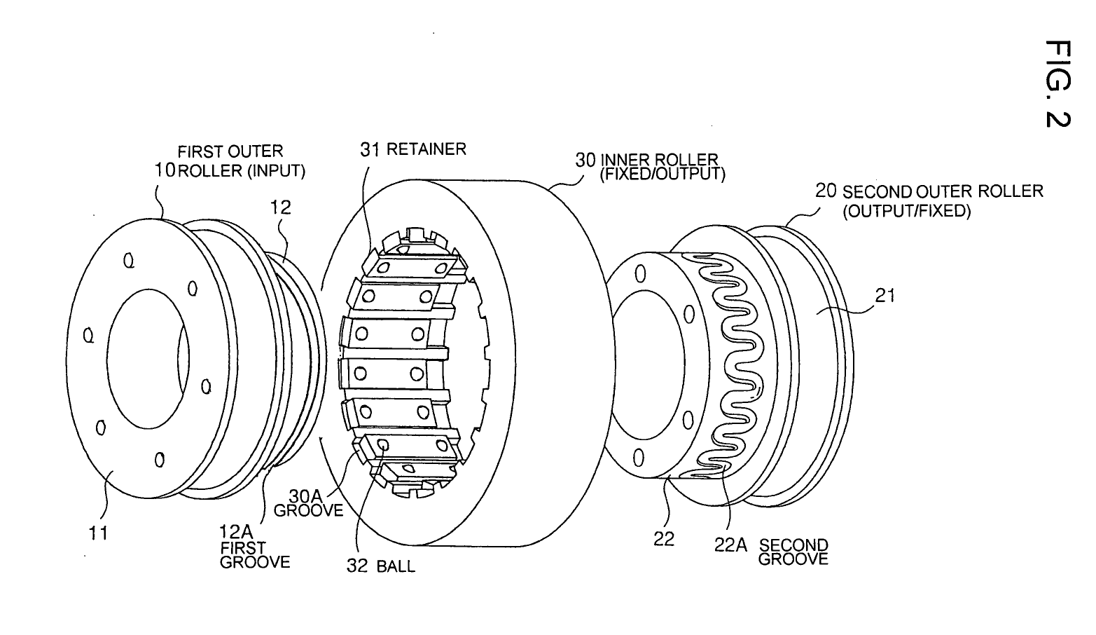

Description will be made regarding an oscillating-type ball reduction gear (hereinafter, referred to as “ball reduction gear”) according to a preferred embodiment of the present invention with reference to FIG. 1 and FIG. 2. The basic configuration of the present ball reduction gear comprises a first outer roller (first roller) 10, second outer roller (second roller) 20, and inner roller (third roller) 30, as illustrated in FIG. 1. With the present embodiment, the first outer roller 10 serves as an input shaft, and one of the second outer roller 20 and the inner roller 30 serves as an output shaft, and the other serves as a fixed shaft.

As illustrated in the exploded view in FIG. 2, the first outer roller 10 comprises a first cylinder body 11 closer to the input side, and a second cylinder body 12 having a smaller diameter than the first cylinder body 11, closer to the output side. A first groove 12A of a first repeated number K_{S} is configured so as to extend in the perimeter direction on the outer diameter portion of the second cylinder body 12. The second outer roller 20 comprises a first cylinder body 21 closer to the output side, and a second cylinder body 22 having a smaller diameter than the first cylinder body 21, closer to the input side. A second groove 22A of a second repeated number K_{S}·K_{I} is configured with essentially the same width as the first groove 12A so as to extend in the perimeter direction on the outer diameter portion of the second cylinder body 22. Note that the first and second grooves 12A and 22A according to the present embodiment are grooves of periodic functional waveforms of which amplitude changes periodically, such as a sine wave or the like, the aforementioned repeated numbers mean how many times the maximum amplitude value is repeated during one cycle, i.e., 360°. Note that the diameter magnitude relation between the first cylinder body 11 and second cylinder body 12, and also the diameter magnitude relation between the first cylinder body 21 and second cylinder body 22 may be in reverse.

The inner roller 30 is also a cylinder body, has an inner diameter in which the second cylinders bodies 12 and 22 can be inserted, and has plural grooves 30A extending in the axial direction with an equal interval in the perimeter direction formed on the inner diameter portion. The maximum number of the grooves 30A to be provided is K_{S}·(K_{I}−1) or K_{S}·(K_{I}+1). A retainer 31 is provided in each groove 30A so as to slide along the groove 30A. The retainer 31 is capable of sliding along the groove 30A, and is not restrained with another retainer 31. Each retainer 31 retains two rolling elements, namely, balls 32 in this case, with an equal interval in the axial direction. Of the two balls 32 retained by the retainer 31, one is configured so as to roll on the first groove 12A of the second cylinder 12, and the other is configured so as to roll on the second groove 22A of the second cylinder 22. The retainer 31 has not only a function for retaining the balls 32, but also a function for receiving tensile/compressive force acting via the two balls 32.

Note that such a structure is accommodated in a casing, and movement of the first and second outer rollers 10 and 20, and the inner roller 30 in the axial direction is restrained with a bearing or the like, as described later. Needless to say, the first and second outer rollers 10 and 20, and the inner roller 30 are combined concentrically.

Also, the number of the grooves 30A in the inner roller 30, i.e., the number of the retainers 31 may be any number in theory as long as the interval n×360°/{K_{S}·(K_{I}±1)} (n is a positive integer) can be retained. Hereinafter, let us define that a case in which the sign in the aforementioned expression is negative is taken as a placement A, and a case in which the sign is positive is taken as a placement B.

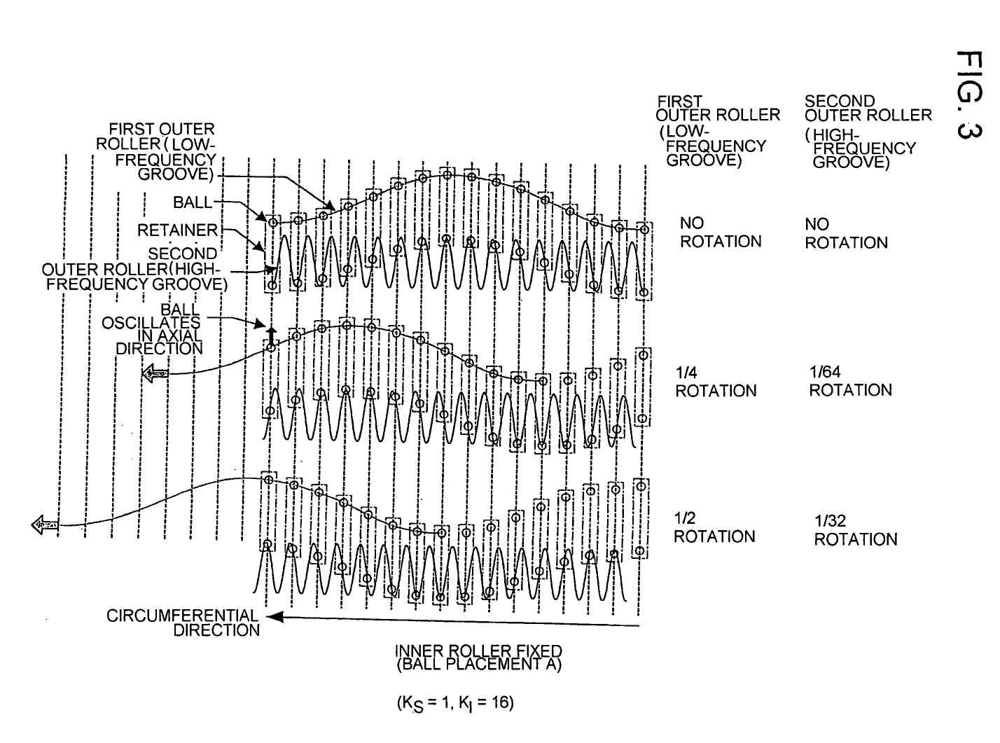

Next, description will be made regarding operational principle with specific embodiments with reference to FIG. 3 through FIG. 6.

Description will be made regarding a case in which the repeated number of the first groove 12A is 1, and the repeated number of the second groove 22A is 16 (i.e., K_{S}=1, and K_{I}=16) as a first embodiment with reference to the opened view in the perimeter direction.

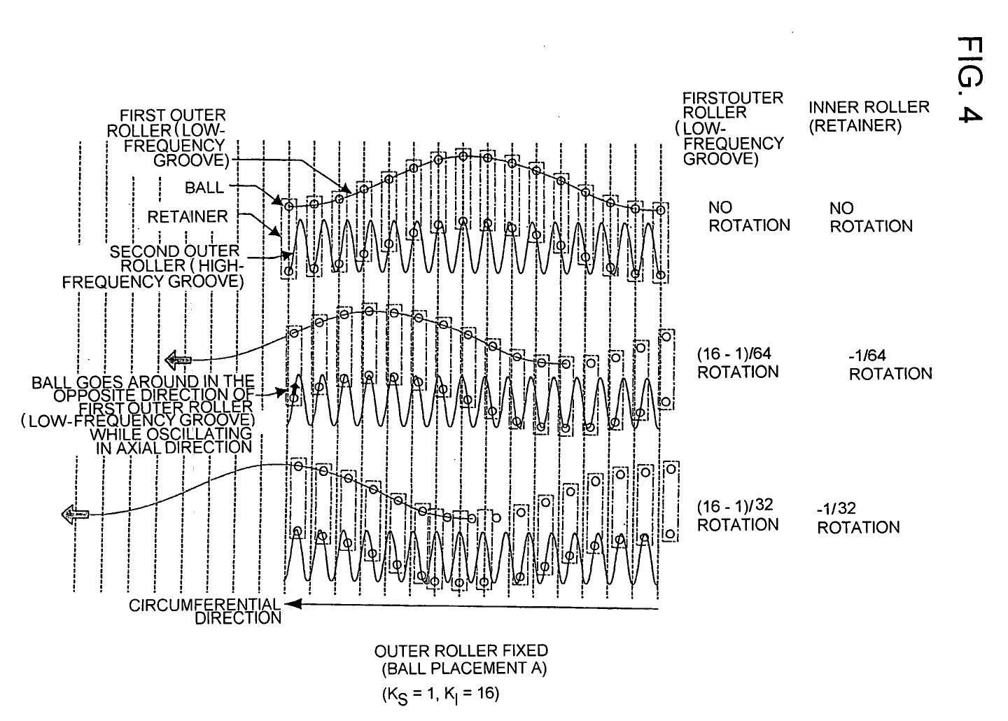

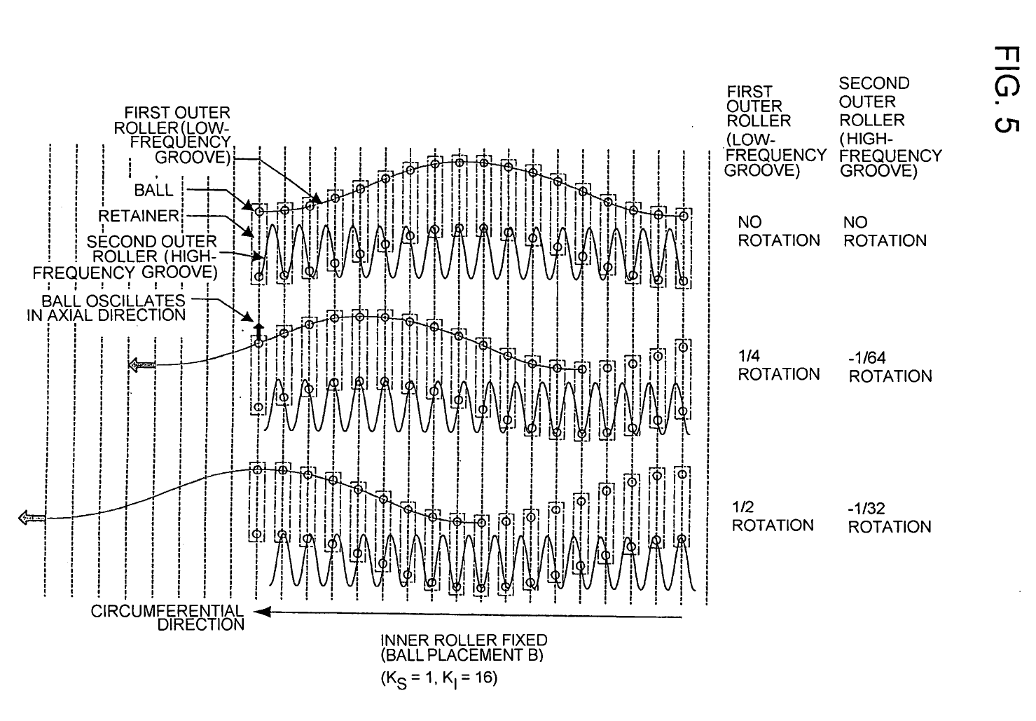

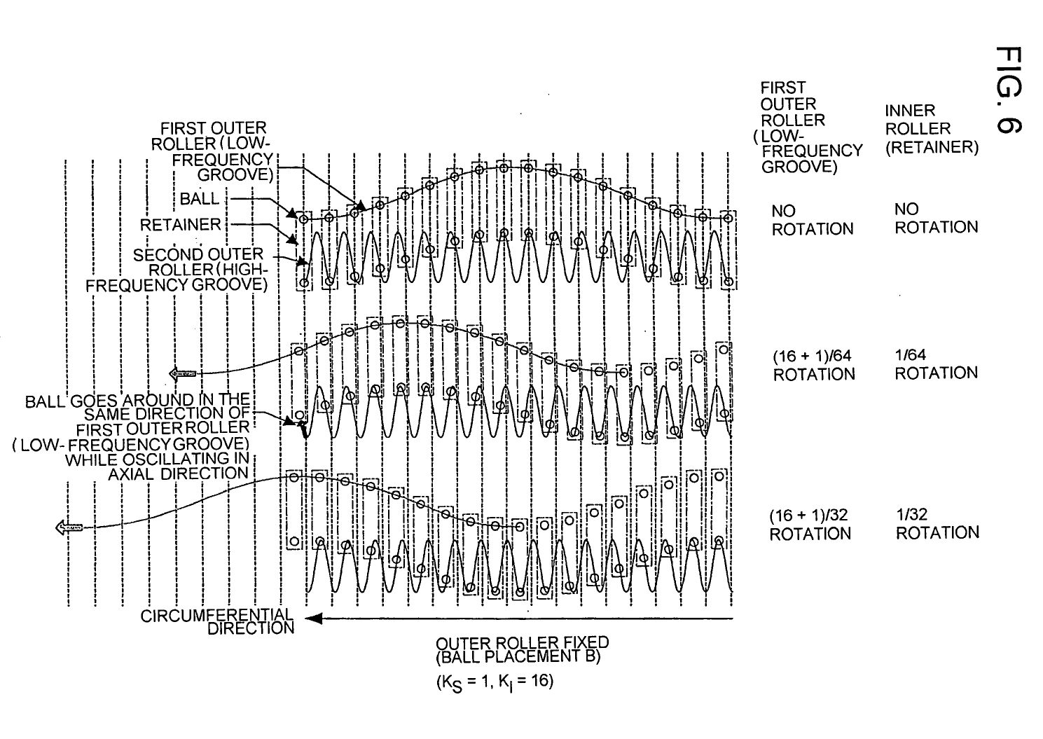

The embodiment in a case in which the grooves 30A in the inner roller 30 is n×360°/{K_{S}·(K_{I}−1)} interval (placement A) is illustrated in FIG. 3 and FIG. 4, and the embodiment in a case in which the grooves 30A in the inner roller 30 is n×360°/{K_{S}·(K_{I}+1)} interval (placement B) is illustrated in FIG. 5 and FIG. 6.

In the event that the inner roller 30 is fixed with the placement A (FIG. 3), i.e., in the event that the retainer 31 is fixed as to the circumferential direction, the retainer 31 and the balls 32 are oscillated in the axial direction due to the first groove 12A in accordance with the first outer roller 10 serving as an input shaft rotating by ¼ and ½, the balls 32 roll in the second groove 22A in the second outer roller 20, so that the second outer roller 20 rotates by 1/64 and 1/32 in the same direction as the first outer roller 10. In this case, a reduction ratio 1/i becomes 1/K_{I}.

On the other hand, in the event that the second outer roller 20 is fixed with the placement A, the entire two phase diagrams on the lower side in FIG. 3 should be moved to the right side so as not to move the second outer roller 20, resulting is FIG. 4. In this case, while the first outer roller 10 rotates by (16−1)/64 and (16−1)/32, rotation of the retainer 31, i.e., rotation of the inner roller 30 becomes in reverse, so rotates by − 1/64 and − 1/32. In this case, the reduction ratio 1/i becomes −1/(K_{I}−1).

Next, in the event that the inner roller 30 is fixed with the placement B (FIG. 5), the second outer roller 20 rotates by − 1/64 and − 1/32 in the opposite direction of the first outer roller 10 in accordance with the first outer roller 10 serving as an input shaft rotating by ¼ and ½. In this case, the reduction ratio 1/i becomes −1/K_{I}.

On the other hand, in the event that the second outer roller 20 is fixed, the entire two phase diagrams on the lower side in FIG. 5 should be moved to the left side so as not to move the second outer roller 20, resulting in the state in FIG. 6. In this case, while the first outer roller 10 rotates by (16+1)/64 and (16+1)/32, rotation of the retainer 31, i.e., rotation of the inner roller 30 is in the same direction, so rotates by 1/64 and 1/32. In this case, the reduction ratio 1/i becomes 1/(K_{I}+1).

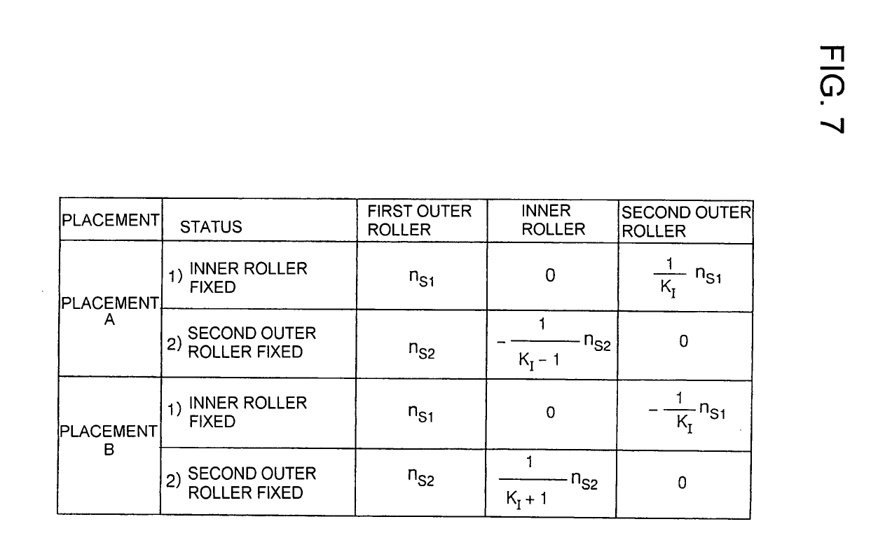

FIG. 7 is a diagram illustrating the relations between the number of rotations and a reduction ratio between the first and second outer rollers 10 and 20, and the inner roller 30.

Description has been made regarding the preferred embodiments of the present invention, but the present invention is not restricted to the aforementioned embodiments, the following modifications may be applied to the embodiments.

While the first and second outer rollers 10 and 20 have been in a hollow cylinder shape respectively, they may be formed of a shaft member having a cross-sectional circular form rather than a hollow form.

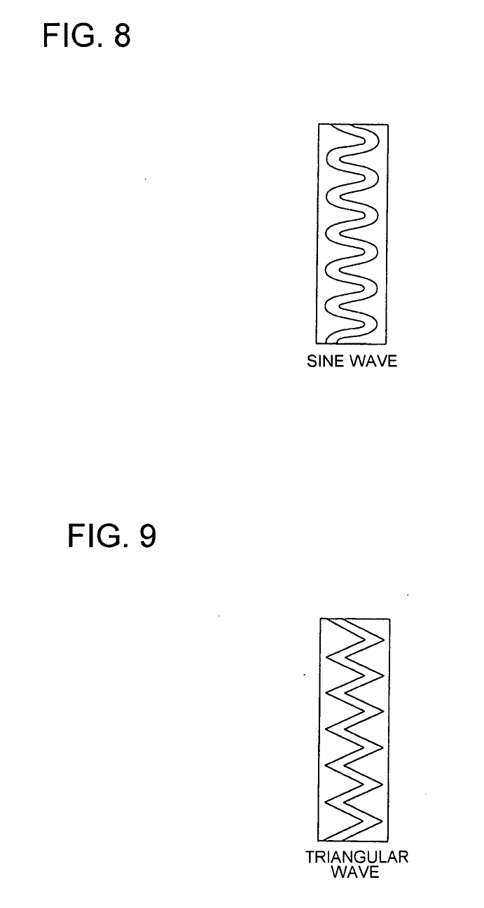

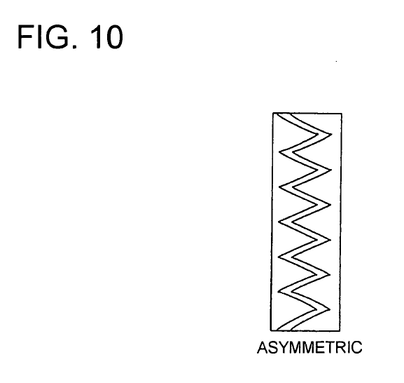

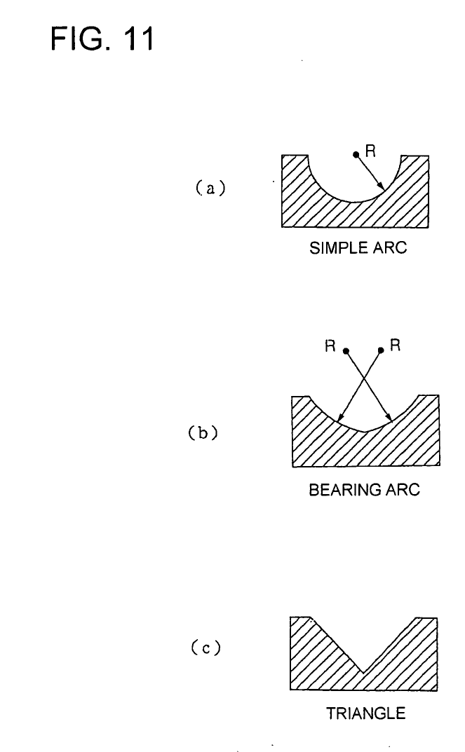

The first and second grooves 12A and 22A may have an asymmetric shape as illustrated in FIG. 10 other than a symmetric shape such as a sine waveform as illustrated in FIG. 8, a triangular waveform as illustrated in FIG. 9, and so forth. In the event of a triangular waveform as illustrated in FIG. 9, a pressure angle can be constant, resulting in constant load fluctuation as to the balls. On the other hand, the cross-sectional shapes of the first and second grooves 12A and 22A may be any one of a simple arc shape as illustrated in FIG. 11(a), a bearing arc shape as illustrated in FIG. 11(b), and a triangular shape as illustrated in FIG. 11(c), but particularly in the event of a bearing arc shape or a triangular shape, a desired pressure angle as to the balls is easy to be obtained, thereby providing an advantage of improving withstand load.

Also, the retainer 31 itself is preferably made up of a material which slides easily, or is preferably coated with a material to facilitate sliding.

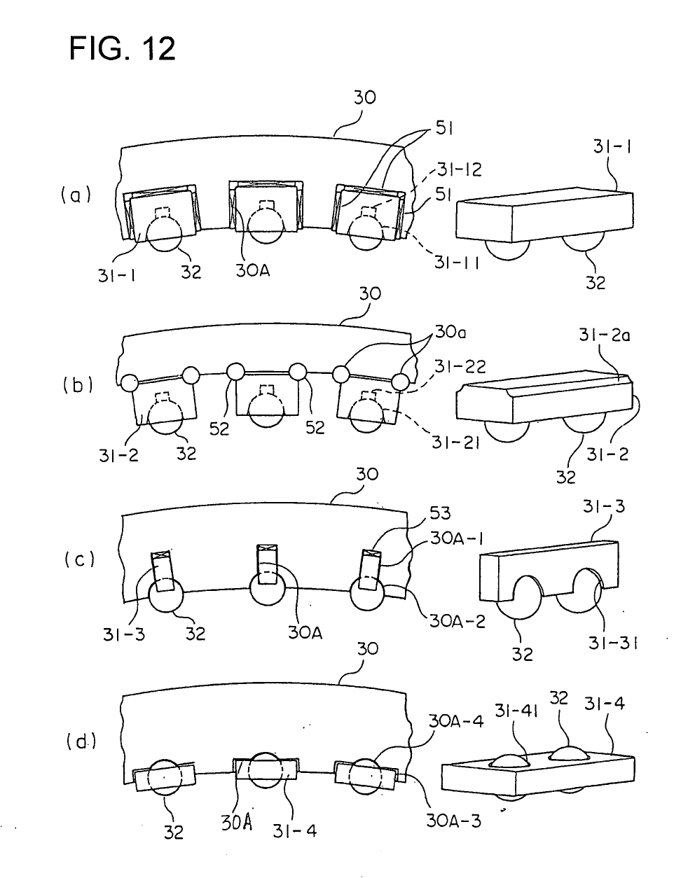

Description will be made regarding another example of the retainer having a function for retaining the balls 32, and also a function for receiving tensile/compressive force with reference to FIG. 12(a) through 12(d). FIG. 12(a) illustrates a first example wherein rolling units 51 intervene between the inner roller 30 and a retainer 31-1 as sliding members. Although the rolling units 51 intervene in the three side surfaces of the retainer 31 facing the inner wall of the cross-sectional-square-shaped groove 30A in the inner roller 30, the rolling unit 51 may be disposed at least on the side surface facing the bottom wall of the groove 30A.

FIG. 12(b) illustrates a second example wherein rolling units 52 intervene between the inner roller 30 and a retainer 31-2 as the sliding members, wherein the rolling units 52 are disposed on the positions corresponding to two corner positions of the retainer 31-2 of the inner roller 30. Accordingly, curved recessed portions 30a and 31-2a for accommodating the rolling unit 52 are formed at the two corner portions of the inner wall of the inner roller 30 and the retainer 31-2, respectively, so as to extend in the axial direction.

Note that with either the aforementioned first example or the second example, a pin roller or the like may be employed as the rolling unit as long as the plural balls can be retained with the retainer, for example.

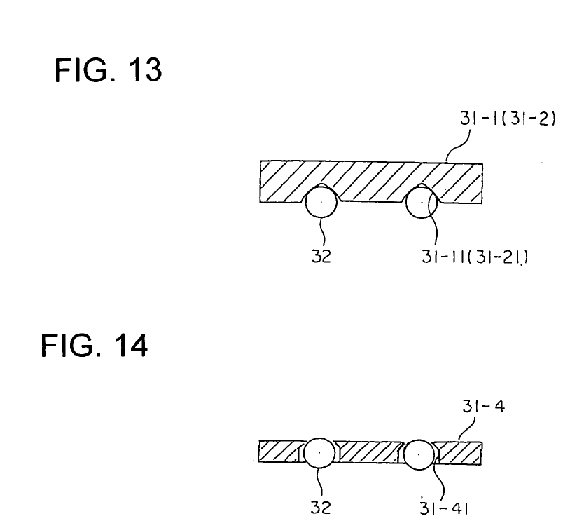

Also, with either the aforementioned first example or the second example, receiving portions 31-11 and 31-21 formed in the retainers 31-1 and 31-2 for accommodating the ball 32 have not an arc shape having the same radius from the perspective of a cross-sectional shape, as illustrated in FIG. 13, but rather a shape wherein arcs having a different center are made to face as described in FIG. 11(b). Needless to say, the shapes of the receiving portions 31-11 and 31-21 are the same shape at any cross-section as long as the cross-section is on a plane passing through the center line of the receiving portion. According to such a receiving portion, a contact radius can be selected according to the size of the ball 32.

In addition, the receiving portions 31-11 and 31-21 are formed using a cutting tool, but in light of clearance of the tip portion of the cutting tool, the receiving portions 31-12 and 31-22 are preferably formed on the penetralia of the receiving portions 31-11 and 31-21. These receiving portions 31-12 and 31-22 can be used as a pool portion in the event that a lubricant is injected in the receiving portions 31-11 and 31-21.

The aforementioned description regarding the receiving portions of the balls 32 is completely applied to a case of the retainer 31 described in FIG. 2.

FIGS. 12(c) and 12(d) illustrate third and fourth examples wherein the balls 32 are configured so as to be also served as the sliding members.

With FIG. 12(d), a retainer 31-3 has a smaller width than the diameter of the ball 32, where a receiving portion 31-31 for holding the ball 32 is formed. The cross-sectional shape of the receiving portion 31-31 may be either an arc shape or sphere shape, which has the same radius. On the other hand, the groove 30A formed in the inner roller 30 has a cross-sectional square portion 30A-1 for accommodating the retainer 31-3, and a curved portion 30A-2 for receiving part of the ball 32. Needless to say, the groove 30A made up of such the cross-sectional square portion 30A-1 and curved portion 30A-2 is formed so as to extend in the axial direction. With this example, a rolling unit 53 is disposed between the bottom portion of the groove 30A and the retainer 31-3 as a sliding member.

Note that, needless to say, the rolling units 51 through 53 in the first through third examples may be realized with other known sliding members. For example, a sliding member may be realized by coating at least one of the facing portions between the retainer and the inner roller 30 with a friction reducing material.

With FIG. 12(d), a retainer 31-4 has a smaller width than the diameter of the ball 32, where a receiving portion 31-41 for holding the ball 32 is formed so as to pass through the retainer 31-4. In other words, the receiving portion 31-41 is formed such that part of the upper portion of the ball 32 and part of the lower portion of the ball 32 are exposed. The cross-sectional shape of the receiving portion 31-41 is not a simple through hole as illustrated in FIG. 14, but is formed such that the upper portion thereof, i.e., the closer to the upper end surface with the side closer to the inner roller 30, the smaller the diameter is. With the cross-sectional shape of the receiving portion 31-41 thus formed, the ball 32 held by the retainer 31-4 can have a function for holding the retainer 31-4. More specifically, in the event that the receiving portion 31-4 is formed as a simple through hole, the retainer 31-4 to be held within the groove 30A of the inner roller 30 drops toward the outer roller side. However, configuring the receiving portion 31-4 in the aforementioned cross-sectional shape can prevent the retainer 31-4 from dropping.

On the other hand, the groove 30A formed in the inner roller 30 has a cross-sectional square portion 30A-3 for accommodating the retainer 31-4 and a curved portion 30A-4 for receiving part of the ball 32. Needless to say, the groove 30A made up of such the cross-sectional square portion 30A-3 and curved portion 30A-4 is formed so as to extend in the axial direction. A recessed portion as with the recessed portions 31-12 and 31-22 described in the first and second examples may be provided on the curved portion 30A-4 in the axial direction as a lubricant receiving portion as necessary. Note that the groove 30A may be realized with the curved portion 30A-4 alone without the cross-sectional square portion 30A-3. In other words, the ball 32 alone may be received by the groove 30A having the curved portion alone.

With the third and fourth examples, the ball 32 rolls in the groove 30A, it can be said that the ball 32 also serves as a sliding member, but a rolling unit may be disposed between the retainer 31-4 and the inner roller 30 even with the fourth example.

Also, with the third and fourth examples, the ball 32 receives force in the tangential direction (force in the tangential direction contacting with the inner diameter of the shown inner roller 30), thereby reducing load affecting the retainers 31-3 and 31-4 by just that much.

Of the aforementioned four examples, the third and fourth examples are superior in that they have an advantage for reducing load affecting the retainers 31-3 and 31-4 as described above, and of these two examples, we can say that the fourth example is the most effective in that the configuration thereof is simple as compared with the first through third examples, and also the cross-sectional area as to tensile/compressive force can be secured double as compared with the other examples.

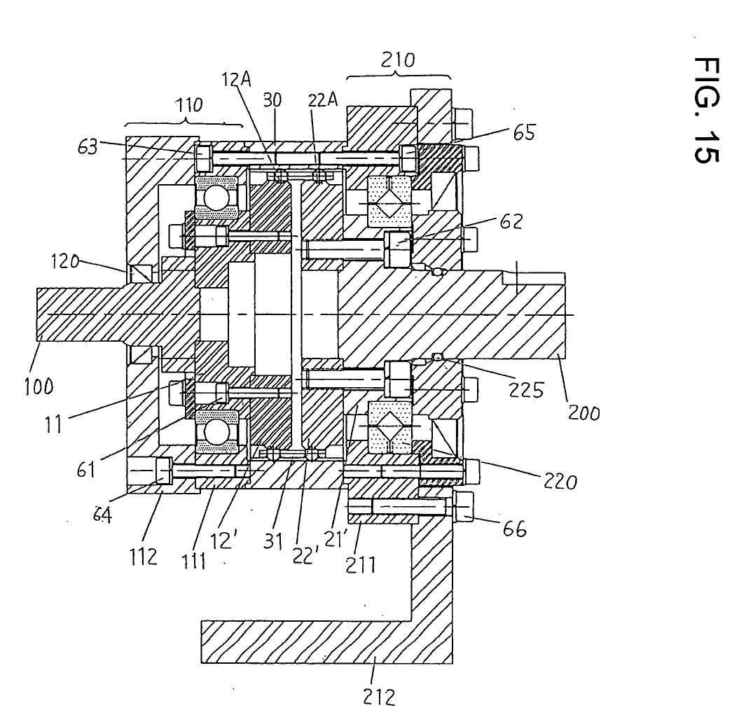

FIG. 15 illustrates the actual device configuration wherein a reduction gear having the same configuration as that illustrated in FIG. 2 is accommodated in a casing. Here, the first outer roller 10 is formed by firmly fixing a first cylinder body 11 closer to the input side to a second cylinder body 12′ having a larger diameter than the first cylinder body 11, closer to the output side with bolts 61 for the sake of facilitating manufacturing. The first groove 12A is formed on the outer diameter portion of the second cylinder body 12′ so as to extend in the perimeter direction. An input shaft 100 is fastened to the first cylinder body 11 with unillustrated bolts. The second outer roller 20 is also formed by firmly fixing a circular plate 21′ having an output shaft 200 integrally to a second cylinder body 22′ having a larger diameter than the second outer roller 20, closer to the input side with bolts 62 for the sake of facilitating manufacturing. The second groove 22A is formed on the outer diameter portion of the second cylinder body 22′ so as to extend in the perimeter direction. An input-side casing 110 made up of a bearing supporting ring 111 and a cover plate 112 is fastened to the input side of the inner roller 30, an output-side casing 210 made up of a bearing supporting ring 211 and an attachment plate 212 is attached to the output side of the inner roller 30. The bearing supporting ring 111 is fastened to the inner roller 30 with bolts 63, and the cover plate 112 is fastened to the bearing supporting ring 111 with bolts 64. On the other hand, the bearing supporting ring 211 is fastened to the inner roller 30 with bolts 65, and the attachment plate 212 is fastened to the bearing supporting ring 211 with bolts 66.

An oil seal 120 is provided between the input shaft 100 and the input-side casing 110. On the other hand, a cross roller bearing 220 is provided between the output shaft 200 and the bearing supporting ring 211 so as to receive load in the thrust direction and in the radial direction. Also, an O-ring 225 is disposed between the output shaft 200 and the attachment plate 212.

The transmission according to the present invention provides advantages as described below.

(1) Working is relatively simple. This is because forming a groove having the repeated number on the inner portion of the first and second outer rollers is not necessary, as described in the first and second examples.

(2) Assembly is relatively simple, thereby realizing longevity of the balls. This is because providing entry plugs for the balls on the ball rolling surface is not necessary, as described in the second and third examples, thereby preventing steps for occurring.

(3) In the event that the first and second outer rollers are formed with a hollow shape, the present invention is particularly suitable for making up the arms of a robot or the like.

The present invention can be applied to reduction gears in general, and is particularly suitable for a driving device required for precision control such as the arms of a robot, automatic tool exchange device, and the like.

While the present invention has thus far been described in connection with preferred embodiments thereof, it will readily be possible for those skilled in the art to put this invention into practice in various other manners.

1. A transmission comprising:
a first roller having a first repeated number of first grooves on the outer circumferential surface of a first shaft body having a cross-sectional circular shape in the perimeter direction;
a second roller having a second repeated number of second grooves, which is different from the first repeated number, in the perimeter direction on the outer circumferential surface of a second shaft body having a cross-sectional circular shape; and
a cylinder-shaped third roller having plural grooves extending in the axial direction with intervals in the perimeter direction on the inner diameter surface;
wherein said first roller and said second roller each face said third roller via plural first rolling elements positioned in said first grooves and plural second rolling elements positioned in said second grooves.

2. A transmission according to claim 1, wherein a retainer capable of sliding in said axial direction for holding said first rolling element and said second rolling element is disposed in each of the plural grooves of said third roller.

3. A transmission according to claim 2, wherein a sliding member intervenes between said retainer and said third roller.

4. A transmission according to claim 3, wherein said sliding member is a rolling unit.

5. A transmission according to claim 3, wherein said first and second rolling elements also serve as said sliding member.

6. A transmission according to claim 1, wherein when said first roller serves as an input shaft, any one of said third roller and said second roller is fixed, and the other serves as an output shaft.

7. A transmission according to claim 2, wherein said first repeated number is represented by K_{S}, said second repeated number is represented by K_{S}·K_{I}, and the maximum number of said plural grooves is represented by K_{S}·(K_{I}±1).

8. A transmission according to claim 1, wherein said first and second rollers are configured with a hollow shape.

9. A transmission according to claim 2, wherein said first and second grooves have a symmetric shape such as a sine waveform, a triangular waveform, or the like.

10. A transmission according to claim 6, wherein said first repeated number is represented by K_{S}, said second repeated number is represented by K_{S}·K_{I}, and the maximum number of said plural grooves is represented by K_{S}·(K_{I}+1).

11. A transmission according to claim 7, wherein said first repeated number is represented by K_{S}, said second repeated number is represented by K_{S}·K_{I}, and the maximum number of said plural grooves is represented by K_{S}·(K_{I}±1).

12. A transmission according to claim 1, wherein said first and second rollers are configured with a hollow shape.

13. A transmission according to claim 6, wherein said first and second rollers are configured with a hollow shape.

14. A transmission according to claim 8, wherein said first and second rollers are configured with a hollow shape.

15. A transmission according to claim 1, wherein said first and second grooves have a symmetric shape such as a sine waveform, a triangular waveform, or the like.

16. A transmission according to claim 6, wherein said first and second grooves have a symmetric shape such as a sine waveform, a triangular waveform, or the like.

17. A transmission according to claim 8, wherein said first and second grooves have a symmetric shape such as a sine waveform, a triangular waveform, or the like.

18. A transmission according to claim 12, wherein said first and second grooves have a symmetric shape such as a sine waveform, a triangular waveform, or the like.
